(19) United States
(12) Patent Application Publication
(10) Pub. No.: US 2004/0172400 A1
(43) Pub. Date: Sep. 2, 2004

(54) Using associative memory to perform database operations

(76) Inventors: Rony Zarom, New York, NY (US); Kenneth Ross, New York, NY (US); Kenneth Yip, Elmhurst, NY (US)

Correspondence Address: Anthony Castorina, G E Ehrlich, Suite 207, 2001 Jefferson Davis Highway, Arlington, VA, 22202, US

(21) Appl. No.: 10/483,409

(22) PCT Filed:
(86) PCT No.: PCT/IL02/00677

Related U.S. Application Data
(60) Provisional application No. 60/312,778, filed on Aug. 16, 2001.

(51) Int. Cl. G06F 17/00

(52) U.S. Cl. 707/100

(57) ABSTRACT

A system and method for employing associative memory for the storing the data of a relational database. The system and method of the present invention optionally include additional hardware components in order for the Associative memory to be usable for the relational database, as CAM (content associated memory).

### FIELD OF THE INVENTION

The present invention is of a system and method which uses associative memory as a co-processor, for example for implementing a relational database, and in particular, for such a system and method in which associative memory is used for more rapid and efficient database operations.

### BACKGROUND OF THE INVENTION

Databases are currently highly important components of information systems, in every field for which computational applications have been developed. Examples of different fields in which databases have become important include, but are not limited to, corporate work, computer-aided design and manufacturing, development of medicine and pharmaceuticals, geographic information systems, defense-related systems, multimedia (text, image, voice, video, and regular data) information systems, and so forth.

Relational database systems provide various capabilities. A central capability of such a system is the ability to query the data according to many different types of criteria. A user formulates a query in a query language such as SQL (sequential query language), and the system executes the query, returning a table containing the answer to the query.

In many applications, such as data warehousing and On-Line Analytic Processing (OLAP), the speed of query operations is the crucial performance measurement. Thus, database system vendors build their query processing engines with query speed as a primary goal.

Queries are typically processed in two phases. In the first phase, known as query optimization, various candidate plans for executing the query are considered. These plans consist of basic relational operations applied either to existing tables, or to tables constructed as intermediate results from other operations. Complex queries may require many basic operations to be composed. The standard operations in relational databases are joins, selections, projections, unions, intersections, differences, and aggregations.

A database system may have several methods available for implementing each operation. For example, three well-known methods for executing a join operation are “sort-merge join”, “nested-loops join”, and “hash join”. The performance of each candidate algorithm depends on the particular characteristics of the data being processed. Based on estimates of these characteristics, a database system may compare many combinations of operators, and many combinations of algorithms for each operator, and choose the particular combination with the smallest anticipated query processing time.

The second phase is called query execution. This phase takes the plan generated by the query optimizer, and actually applies the algorithms to the data, in order to generate the answer to the user's query.

As previously described, a number of database operations, such as join operations for example, are known in the art. A join operation receives two tables and produces a third table in which records from the two source tables are combined according to some combination predicate. Such combination predicate, with the request to perform the join, is an example of a query as that term is used above, as it controls the operation to be performed on the data. The most common type of join is one in which the combination predicate is an equality condition, specifying that the value of one column in one source table must match the value of another column in the second source table. This type of join operation is called an equijoin operation.

Various join algorithms have been proposed in the art. The most commonly employed algorithms are sort-merge join, nested loops join, and hash-join. For example, to perform an equijoin of tables A and B, where both A and B have a column named K, the join operation requires the A.K value to match the B.K value. A sort-merge join would sort both A and B in order of the K attribute. A single pass through the sorted results would be sufficient to merge records with matching K values. If one (or both) of A and B were already sorted in K order, some sorting could be avoided.

A nested loops join would compare every record in A against every record in B, checking whether the K values match. Each match generates an output record.

A hash join would proceed as follows. One of the tables, usually the smaller table, is chosen to be the “build” table. Suppose that B is the build table. An in-memory hash table is built, and every record in B is inserted into the hash table using a hash function on B.K. After the hash table is built, the other table, known as the “probe” table is scanned. If A was the probe table, then for each scanned record of A, a hash function would be used on A.K to see if there were any matching records in the hash table. Each match generates an output record.

Each of these methods has different performance characteristics that make them preferable in certain situations.

Both nested loops join and hash join perform poorly when both tables are relatively large. In that case, a well-known partitioning technique is applied. Data from both source tables are partitioned into a large number of partitions based on the value of column K. This forces matching records for an equijoin to be in corresponding partitions. If the data is partitioned sufficiently well (using one or more partitioning passes), then many smaller subproblems remain in which corresponding partitions are joined. Each of these subproblems can use one of the algorithms mentioned above.

Although these different algorithms may optionally be performed with any type of hardware, certain types of hardware may be expected to perform more efficiently. In particularly, different database operations, such as searching, retrieving, sorting, updating, and modifying non-numeric data can be significantly improved by the use of CAM, or content-addressable memory, instead of location-addressable memory. The difference between most types of memory and CAM type memory is that generally, an address is used to extract data from most types of memory. By contrast, content is used to extract the location of data from CAM type memory. Data retrieval is therefore much faster and more efficient, since searches through CAM for data involve comparisons against the entire list of stored data entries simultaneously. CAM is particularly suitable for such applications as network address lookup functions and/or other types of lookup tables; filtering of data, for example to filter packets according to addresses or other types of information; and encryption information or other types of parameterized data.

Currently, relatively few hardware solutions are available for operating CAM type memories. For example, CAM devices can be constructed from programmable logic devices (PLDs). Multiple chips can be linked together to form larger CAM memory devices. However, CAM devices are not currently efficient for very large databases, because as the array of CAM devices increases past a particular size, access times increase significantly. Issues of power consumption and device size also become important for large arrays of CAM devices. Also, CAM devices have not been previously interoperable with other type of computational hardware, as they required specialized hardware. Currently, CAM devices have not been implemented for large-scale use, or even greater use in a single computational device, due to the difficulty and high cost of implementing CAM devices in conventional hardware. Until now, CAMs have only been included in computers systems as small auxiliary units. Thus, CAM devices that are known in the art suffer from a number of drawbacks.

### SUMMARY OF THE INVENTION

The background art does not teach or suggest a system or method for more efficiently accessing memory in order to process and execute queries. The background art also does not teach or suggest such a system or method which uses associative memory for more efficient memory access and usage.

The present invention overcomes these deficiencies of the background art by providing a device, system and method for employing associative memory as a co-processor for performing various database operations. For example, the associative memory may optionally be used for storing at least a portion of the data of a relational database. The system and method of the present invention optionally include additional hardware components in order for the associative memory to be usable for the relational database, as CAM (content associated memory). Preferably, the associative memory receives the data on which one or more operations are to be performed from the main processor or CPU, and then performs the requested operation(s). The results may optionally be filtered before being returned to the user.

Among other advantages, the present invention features an improvement to query processing algorithms for relational databases. The improvement is optionally and preferably achieved with a combination of hardware and software.

The hardware component of the proposed system involves an associative memory, often referred to as a Content Addressable Memory, or CAM. A hardware device containing a large amount of CAM storage, together with some additional circuitry for processing queries, is termed herein a CAM unit or alternatively a CAM co-processor unit (the two terms are used interchangeably herein). In one embodiment of the invention, the CAM unit would be attached to a high-bandwidth bus within a computer system.

The software component of the system involves algorithms for computing several relational operations. These algorithms make essential use of the CAM unit and offer significant performance advantages over previously known systems.

An important advantage of the present invention is that it can be used with many different kinds of computing devices, running many different kinds of database software. Therefore, unlike background art CAM devices, the device and system of the present invention are clearly interoperable with a number of different hardware devices, particularly for advanced database operations.

Other advantages of the present invention include but are not limited to, the use of a bit vector flag to record probe operations, particularly for performing certain types of join and outerjoin operations. The present invention can also flexibly be configured to perform many different types of join, aggregation and duplicate elimination operations. These operations themselves are performed in a particularly advantageous manner by the present invention, as are the outerjoin, semijoin and antisemijoin methods.

The present invention is also advantageous in that it permits selection operations on one or both of the input records and the output records, to be combined with a join, aggregate or duplicate elimination operation.

According to preferred embodiments of the present invention, configuration data and specialized circuitry enable special actions to be performed on rows with NULL values, in order to adhere to the standard of SQL communication. This adherence to the SQL standard is important, as it enables the present invention to be in conformance with database standards and therefore to be operable with existing database protocols and software. Furthermore, relational databases which are known in the art cannot operate on CAM devices efficiently, with regard to currently available relational database architectures, because relational databases operate most efficiently when the data is evenly distributed throughout the storage medium. By contrast, CAM devices tend to place data into groups, which are not efficient for relational database operation. The present invention overcomes these drawbacks by providing selected functionality for operating with relational database software and communication standards, such as SQL, without requiring the entire relational database architecture to be implemented in the CAM device.

According to other preferred embodiments of the present invention, several CAM units are preferably used in parallel. Data may then optionally and preferably be partitioned between the units according to a partitioning function. As for other aspects of the function of the present invention, such partitioning may optionally be preformed by hardware, software, firmware or a combination thereof. Optionally and more preferably, a plurality of FIFO buffers are used for the input data and/or for the output data, thereby enabling the application to send and/or receive data row by row or column by column. Since the operation of CAM units actually depends upon the data (content) of the memory, greater flexibility in terms of receiving and/or transmitting the data also increases the efficiency of operation of CAM co-processor units. Thus, the device and system of the present invention are preferably implemented in a manner which is more flexible and hence more efficient for operation with different types of data.

Generally, the functions of the present invention may optionally be embodied in hardware, software, firmware or a combination thereof. The actual implementation of any particular function, apart from the use of CAM co-processor units, and/or CAM units, is not restricted by the present invention, such that the present invention encompasses all of the different implementations which could be performed by one of ordinary skill in the art.

The present invention is also clearly not limited by the type of CAM devices which are used. Any such devices or any other type of CAM component, are considered to be different forms of CAM and are therefore encompassed by the present invention. For example, an optical CAM would also be encompassed by the present invention (see for example http://www.ece.arizona.edu/department/ocppl/papers/ao_{—}09_{—}1999_{—}1.pdf as of Jul. 19, 2002), as well as silicon CAMs, or any other type of CAM, alone or in combination.

Hereinafter, the term “database operation” refers to any type of operation which may be performed on data, including but not limited to, relational database operations, such as those based upon SQL for example.

### BRIEF DESCRIPTION OF THE DRAWINGS

The invention is herein described, by way of example only, with reference to the accompanying drawings, wherein:

FIG. 1 is a schematic block diagram showing an exemplary embodiment of a computer system according to the present invention;

FIGS. 2A and 2B are schematic block diagrams of exemplary CAM units for use with the system of FIG. 1;

FIG. 3 shows an exemplary configuration for operating several CAM units in parallel; and

FIGS. 4A-C show flowcharts of exemplary methods according to the present invention for operating the CAM unit and/or system of the present invention.

### DESCRIPTION OF THE PREFERRED EMBODIMENTS

The present invention is of a system and method for employing associative memory for performing one or more operations on data as a co-processor, for example for storing at least a portion of the data of a relational database. The system and method of the present invention optionally include additional hardware components in order for the associative memory to be usable for the relational database, as CAM (content addressable memory). As a co-processor, the associative memory preferably features at least one CAM device, and at least some type of logic to assist with data operations.

It should be noted that the term “co-processor” does not necessarily require the associative memory unit to feature a processor, such as a CPU for example. Instead, the co-processor may optionally only feature a logic of some type for performing a particular set of operations. Alternatively and preferably, the co-processor features a processor, such as a CPU for example, which executes one or more instructions in order to perform various operations. These different configurations are described in greater detail below.

At least one hardware component of the proposed system preferably includes an associative memory, often referred to as a Content Addressable Memory, or CAM. A hardware device containing a large amount of CAM storage, together with some additional circuitry for processing queries, is a CAM unit (CAM co-processor unit or CAM co-processor). In one embodiment of the invention, the CAM unit would be attached to a high-bandwidth bus within a computer system.

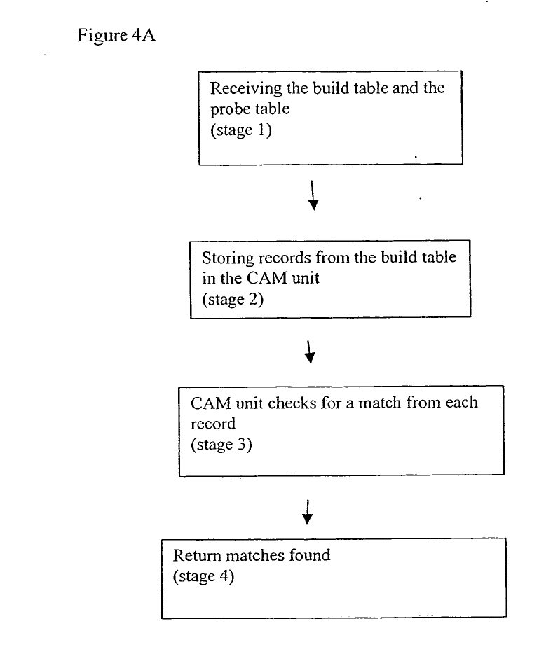

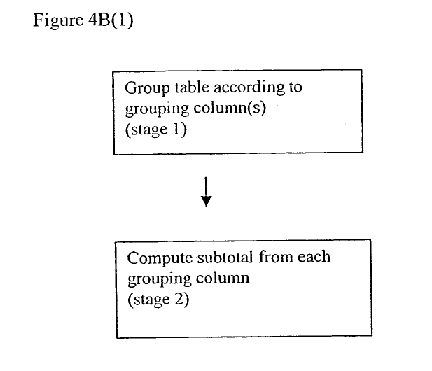

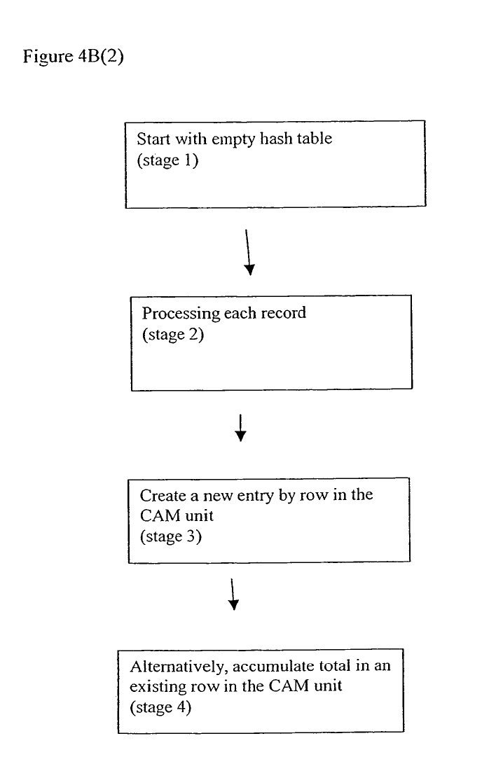

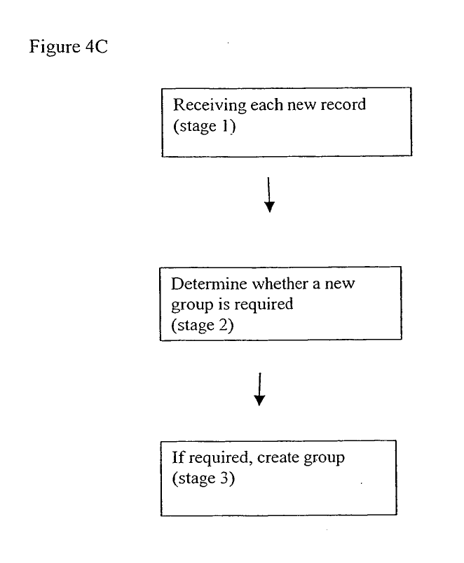

The software component of the proposed system involves algorithms for computing several relational operations. These algorithms make essential use of the CAM unit. Examples of such relational database operations include but are not limited to, selection, projection, join, grouping and aggregation, and sorting. Examples of these different operations are described below with regard to FIG. 4.

One critical advantage of CAM memory is that it can search a large number (tens of thousands or more) of memory locations in parallel for a match with a lookup key. In a small number of cycles, the matches (if they exist) may be output. A naive search of the same data in conventional DRAM memory would require a sequential search of each memory location, one by one. Thus, the use of CAM memory for locating data, and hence for reading and/or writing data, can clearly be more efficient than performing similar operations on conventional non-associative memory devices.

Each CAM unit has a capacity, which refers to the number of memory locations that are searched in parallel. A CAM unit might optionally be configured in various ways. For example, it may be configured so that it has a smaller capacity but wider keys for searching. The capacity is limited by the hardware on the CAM unit. In a preferred embodiment, the CAM unit is preferably able to accommodate hundreds of thousands, or even millions of keys for searching. A CAM unit is also optionally and more preferably configurable so that many tables having different formats (key widths, associated data widths, etc.) could be stored, as long as the aggregate capacity of the CAM unit is not exceeded.

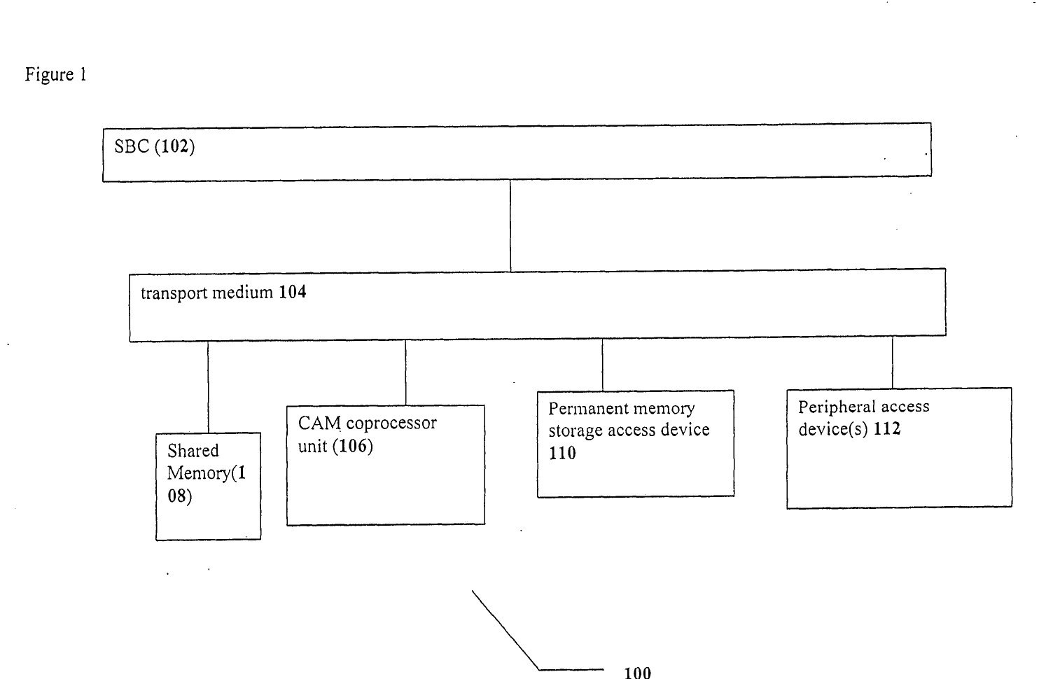

The principles and operation of the system and method according to the present invention may be better understood with reference to the drawings and the accompanying description. FIGS. 1-3 describe different exemplary configurations of the system and device according to the present invention. FIG. 4 describes exemplary methods for operating the system and device according to the present invention.

Referring now to the drawings, FIG. 1 shows, at a high level, a preferred embodiment of a system according to the present invention.

An important advantage of the proposed invention is that it can be used with many different kinds of computing devices, running many different kinds of database software.

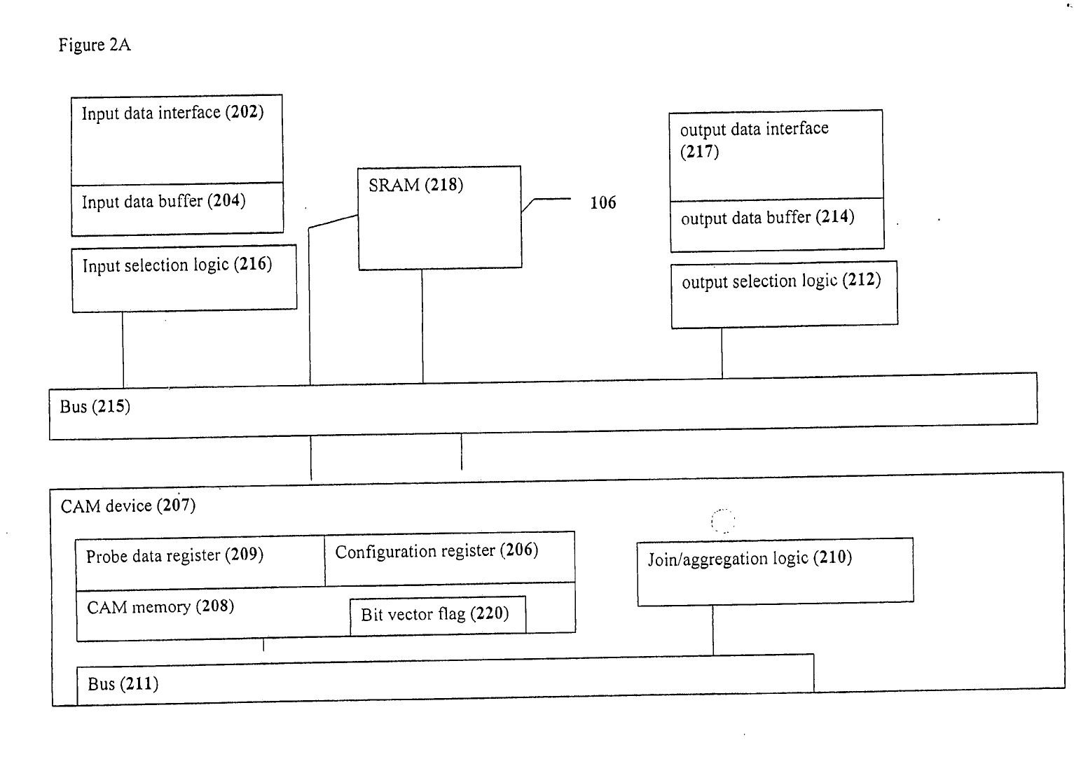

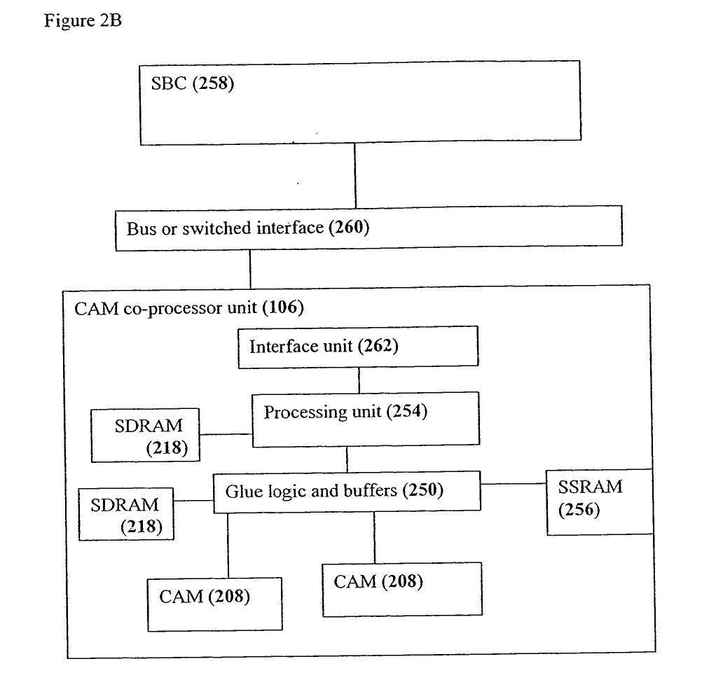

As shown in FIG. 1, a system 100 features at least one processing unit, shown as a SBC (single board computer) 102. See FIG. 2B for a description of single board computers. A plurality of such processing units may also optionally be employed, for example connected by an internal bus (not shown). Each SBC 102 communicates with a transport medium 104.

Transport medium 104 in turn communicates with one or more CAM coprocessor units 106. Each CAM coprocessor unit 106 features at least one CAM (not shown), which in an optional but preferred embodiment of the invention is a solid state memory with response times at least as rapid as response times of SRAM devices. Such memory is available commercially today in chip form.

Transport medium 104 which may optionally be implemented as a bus as shown. Alternatively, transport medium 104 may optionally be implemented as a switch. The latter structure is preferred when SBC 102 communicates with a plurality of CAM coprocessor units 106.

In addition, system 100 optionally and preferably also features an additional shared memory 108, and one or more permanent memory storage access devices 110. Permanent memory storage access devices 110 are optionally and preferably implemented as non-CAM devices, such as magnetic storage media and/or optical storage media, for example. Optionally and more preferably, system 100 also features other peripheral access devices 112 connected to transport medium 104, for performing different types of computational functions.

According to optional but preferred embodiments of the present invention, a plurality of SBCs 102 could optionally be implemented, alternatively or additionally with a plurality of CAM coprocessor units 106. The possible implementation of a plurality of CPUs and/or a plurality of CAM units, or CAM devices (as for FIG. 2A or 2B below), may optionally be used in place of, or in addition to, the implementations shown herein.

Exemplary preferred embodiments of CAM coprocessor units 106 are described in greater detail below. Briefly, CAM coprocessor unit 106 preferably acts a co-processor to SBC 102. As described above, CAM coprocessor unit 106 does not necessarily need to feature a processor of some type, such as a CPU for example, to act as a co-processor. Instead, CAM coprocessor unit 106 preferably receives data and information about one or more operations to be performed on the data, from SBC 102. CAM coprocessor unit 106 then preferably performs the operation(s) on the data and returns the result, optionally filtering the results before they are returned. This configuration enables SBC 102 to operate more efficiently, and also enables the operations to be performed more efficiently on the data.

Optionally and more preferably, the flow of operations is as follows. SBC 102 receives a query, and preferably also retrieves data to execute the query from a database, such as from permanent memory storage access device 110. The query may optionally be optimized, as is known in the art. Next, a strategy for executing the query is preferably determined by SBC 102, for example according to one or more instructions, such as from database software for example.

SBC 102 may then optionally and more preferably transmit the strategy for executing the query to CAM coprocessor unit 106, for creating an execution plan. CAM coprocessor unit 106 may then more preferably create some type of code, such as pseudocode or machine code, depending upon the type of implementation, for executing the instructions according to the execution plan. The code is then preferably executed by CAM coprocessor unit 106 and the results are returned.

The ability to create code preferably depends upon the type of implementation of CAM coprocessor unit 106. As described in greater detail below with regard to FIGS. 2A and 2B, CAM coprocessor unit 106 may optionally feature only execution logic (FIG. 2A) or alternatively may also feature a CPU (FIG. 2B). For the former implementation, the code is preferably constructed from a plurality of predetermined execution instructions, which are preferably selected according to a fixed mapping between the predetermined instructions and the received strategy. The execution plan would therefore preferably feature the mapping between each part of the strategy and the predetermined instruction which is to be executed.

Alternatively, if CAM coprocessor unit 106 features a CPU, then the code may optionally be constructed in real time from much simpler and more flexible operations, such that the execution instructions themselves would not necessarily need to be predetermined. Instead, the CPU of CAM coprocessor unit 106 could optionally and preferably construct machine-language code from the strategy, such that the execution plant would include information for creating machine language code according to the machine language, rather than according to predetermined instructions.

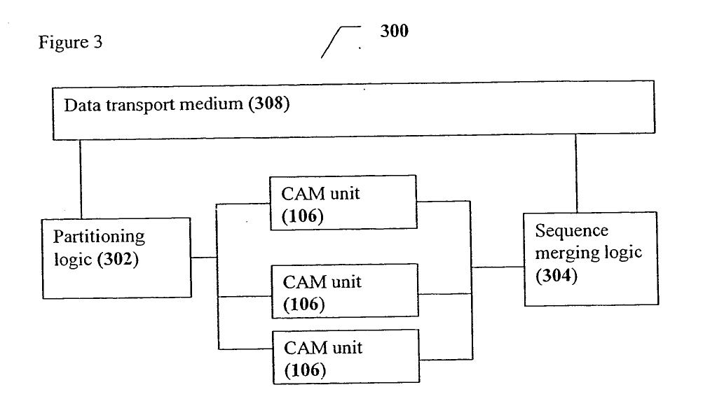

FIGS. 2A and 2B illustrate the components of two different preferred but exemplary implementations of CAM coprocessor unit 106. For FIGS. 2A and B, and FIG. 3, data is assumed to be passed to CAM coprocessor unit 106 from an originating application (not shown), which optionally and preferably generates the data and the query for performing the operation on the data. Both the data and the query are optionally and more preferably passed to CAM coprocessor unit 106. The originating application is preferably operated by SBC 102 of FIG. 1 (not shown). It should be noted that FIG. 2A is a logic diagram of one optional implementation of the present invention, and that a plurality of different physical implementations of this logic diagram could optionally be constructed, as long as the resultant CAM unit maintained the functionality shown.

As shown with regard to FIG. 2A, this exemplary implementation of CAM coprocessor unit 106 preferably does not feature a CPU. Instead, CAM coprocessor unit 106 preferably features some type of operational logic, for performing a restricted set of operations. As shown herein, this operational logic includes an input selection logic 216 and an output selection logic 212. Input selection logic 216 is preferably connected to an internal bus 215 of CAM coprocessor unit 106 through an input buffer 204, which may optionally and preferably be implemented as a FIFO buffer for example. Output selection logic 212 is preferably connected to internal bus 215 through an output buffer 214, which may also optionally and preferably be implemented as a FIFO buffer for example. Input selection logic 216 preferably filters incoming data with one or more operations to be performed on the data, in order for the operations to be executed by a CAM device 207. Output selection logic 212 optionally and preferably filters the results of the executed operations by CAM device 207, for example in order to place the results in the correct format for the originating application.

Optionally and more preferably a plurality of input buffers 204 are implemented (not shown), more preferably to enable data to be received in different formats, such as row-by-row or column-by-column, for example. This flexibility is particularly advantageous for receiving data from relational databases, for example, in which the data is already organized in a tabular format. The data may therefore optionally be received in a column oriented or row oriented fashion for such tabular data, according to the requirements of the originating application. CAM coprocessor unit 106 preferably uses an input buffer 204 for each column, and then preferably reconstructs the record from these columns as necessary. Double buffering techniques are preferably used to allow CAM coprocessor unit 106 to process a sequence of rows while at the same time loading data for the subsequent sequence of rows. The flexibility of data formats allows CAM coprocessor unit 106 to be efficiently used by a variety of database platforms employing various data formats.

Input data with information about one or more operations is preferably received by CAM coprocessor unit 106 through an input data interface 202. Input data interface 202 in turn preferably transmits the data to input buffer 204 through bus 215. Input selection logic 216 then preferably receives the data, optionally and more preferably with information about one or more operations to be performed on the data, such as a query for example.

For a typical database search, particularly according to a relational database search structure, optionally and preferably two types of data are placed in input buffer 204. The first type is the probe data, or information regarding the query. The second type is the data to be searched itself. Since CAM-type memory is expensive and may be difficult to configure, preferably the data to be searched (or through which a search is to be made) is not actually stored permanently in the CAM-type memory, but instead is placed into such memory temporarily, in order for the search to be performed, as described in greater detail below.

Received data is then more preferably transferred from input buffer 204 to input selection filter 216, rather than being transferred directly to CAM device 207. Input selection filter 216 optionally and more preferably filters the received data, which is then transmitted on bus 215 to CAM device 207, for storage in at least one probe data register 209 and also for storage in a CAM memory 208. The precise configuration of input selection filter 216 is optionally and more preferably set by the application which is providing instructions to CAM coprocessor unit 106 at the start of each operation. However, input selection filter 216 is preferably able to at least transmit the probe table data to probe data register 209, and to transmit the build table data to CAM 208. The probe table data is data that is associated with the probe key, as previously described. Also as previously described, the build table data is preferably only temporarily stored in CAM 208.

According to a preferred embodiment of the present invention, one or more configuration registers 206 on CAM device 207 store data which is used to control the behavior of other components of CAM coprocessor unit 106. Each configuration register 206 preferably receives the data from input buffer 204. Examples of data to be contained in configuration register(s) 206 include the machine representation for the SQL NULL value, which may be configured during the initialization of each operation. Additional configuration registers 206 may optionally be set to define the behavior of the join when the join key is NULL, or to define the behavior of an aggregate function when the value being aggregated is NULL. Such parameters are useful for ensuring compatibility with the SQL relational database standard. Furthermore, such parameters are examples of the implementation of a CAM coprocessor unit 106 which is capable of communicating with relational databases and/or adhering to relational database standards, without actually implementing a relational database architecture.

Additional configuration parameters which are optionally stored in configuration registers 206 preferably describe the width of the associated key and non-key columns for the build and probe tables, and the data types of these columns (e.g., integer or floating point).

According to preferred embodiments of the present invention, CAM coprocessor unit 106 operates according to various configuration parameters that indicate the kind of operation being performed. These configuration parameters preferably include several kinds of joins (detailed below), several kinds of aggregation (detailed below), and duplicate elimination operations.

According to other preferred embodiments of the present invention, the data that is associated with the probe key and that is stored in one or more probe data registers 209, is combined with information that is retrieved as a result of a database operation on the data stored in CAM memory 208, such as a “join” operation. For example, for several of the join operations that are described in greater detail below, each successful match results in an output record that combines this probe-related data with the data for matching build records. For several of the aggregation operations, this probe-related data is preferably aggregated into the appropriate running subtotals. Circuitry for performing arithmetic operations for such aggregation is preferably included in CAM device 207, and is shown as a join and aggregation logic 210. Join and aggregation logic 210 is intended as a non-limiting example of a data processing logic.

It should be noted that CAM device 207 could optionally be replaced with any type of commercially available CAM memory device, as long as it retained the functionality shown. For example, if the commercially available device lacked join and aggregation logic 210, then optionally the additional logic shown in FIG. 2B below as a glue logic could be added to that commercially available device, in order to provide the necessary logic.

Join and aggregation logic 210 preferably communicates with CAM memory 208 through a bus 211. Join and aggregation logic 210 preferably executes the algorithms which are necessary for performing the data operations according to the query. Optionally and preferably, as previously described, join and aggregation logic 210 receives the query as an execution plan. The execution plan includes a description for performing a number of steps, each of which either retrieves rows of data physically from the database or prepares the data in some way for the user who sent the query. For example, for a join statement, the execution plan includes an access path for each table that the query needs to access, and an ordering of the tables (the join order) with the appropriate join method.

Join and aggregation logic 210 then preferably creates code for execution from a plurality of predetermined building blocks, each of which represents a particular instruction. Join and aggregation logic 210 then executes the instructions according to the execution plan. Examples of algorithms to be executed are described in greater detail below with regard to FIGS. 4A-4C.

According to optional but preferred embodiments of the present invention, preferably CAM device 207 communicates with an associated SRAM memory 218 to store non-key data that is associated with each key. It should be noted that although SRAM memory 218 is described as being an SRAM (static RAM (random access memory)), it could optionally be any type of RAM memory, such as DRAM (dynamic RAM) or a synchronous type RAM memory device, as SRAM is a non-limiting illustrative example only. SRAM memory 218 preferably acts as an extension of CAM memory 208, for example for performing the algorithms of join and aggregation logic 210. SRAM memory 218 preferably communicates with CAM device 207 through bus 215. Also, CAM device 207 preferably features a bit vector flag 220, with one bit available for each slot in CAM memory 208. Each bit is set to zero initially, and later set to one if a probe encounters a match at that particular slot.

After the operation(s) have been performed by CAM device 207, the data is transmitted to output selection logic 212 through a bus 215. Output selection logic 212 preferably filters the results of the data operation(s), for example in order to only transmit the part of the result which is required by the query. The filtered data is then preferably stored in output buffer 214, more preferably according to the format which is required by the originating application (not shown), which originally transmitted the query. The data is then preferably sent out of CAM coprocessor unit 106 through an output data interface 217.

FIG. 2B shows a second configuration of CAM coprocessor unit 106 as a co-processor for SBC (single board computer) 258, which is an example of a main CPU. A single board computer may optionally be obtained from a number of different commercial sources, such as Intel Corp., USA, and typically includes memory and one or more I/O interfaces (user I/O and system I/O, communicates with co-processor (CAM coprocessor unit 106). SBC 258 may also optionally include one or more buffers. For this implementation, the system I/O interface of SBC 258 preferably communicates with CAM coprocessor unit 106 through a bus or switched interface 260. As noted previously, a switched interface is preferred if SBC 258 communicates with a plurality of CAM memories 208, as shown below. CAM coprocessor unit 106 preferably features an interface unit 262 which is directly connected to bus or switched interface 260.

According to this configuration, CAM coprocessor unit 106 preferably features a CPU 254, which optionally and preferably executes a plurality of instructions for performing the operation(s) that are required according to the query. These instructions are preferably stored on a memory 256, which may optionally be implemented as a SSRAM memory device for example as shown. Another optional type of memory is SDRAM 218, as previously described. This implementation gives more flexibility to the type of instructions which may optionally be executed, and also optionally as to how these instructions may be constructed for execution. For example, as previously described, the instructions may optionally be received as a plurality of building blocks and an execution plan. For this implementation, the building blocks may optionally and more preferably be converted to machine code by CPU 254 and to be stored on memory 256, rather than being converted to a plurality of predetermined instructions.

CPU 254 preferably communicates with CAM memory 208, and optionally with an associated SRAM 218, through bus 252. CAM memory 208, and optionally also SRAM 218, are preferably connected to bus 252 through a buffer 250. Buffer 250 may optionally be constructed as a FIFO buffer, for example. Buffer 250 also optionally and preferably includes a glue logic as shown, for communication with CPU 254, if necessary. If CPU 254 is able to communicate directly with one or more CAM memories 208, then glue logic may not be necessary.

As shown in FIG. 3, to enhance the performance of a CAM unit, multiple CAM coprocessor units 106 could optionally be placed within a single system 300. There are several ways this could be achieved. In one preferred embodiment, multiple CAM coprocessor units 106 are optionally placed on a single processor board. In another preferred embodiment, several boards may optionally feature CAM coprocessor units 106 in a single system. The performance enhancement is derived from parallel operation of CAM coprocessor units 106. In any case, system 300 preferably features a data transport medium 308 for transmitting the data to multiple CAM units 106.

More preferably, as shown, data transport medium 308 is not connected directly to the plurality of CAM coprocessor units 106. Instead, a partitioning logic 302 is preferably placed between data transport medium 308 and CAM coprocessor units 106 so that the keys for identifying each type of data are partitioned among the available CAM coprocessor units 106 in a manner that is close to being uniformly distributed. The partitioning is preferably based upon the key itself, so that each key always maps consistently to the same CAM coprocessor unit 106. For example, the key could optionally be a primary key for describing the data in a particular table. Thus, the data is logically partitioned between CAM coprocessor units 106, preferably according to the keys, although optionally any type of data description could be used for such partitioning.

The data to be searched or otherwise operated upon, and the query (operational description) itself, would then preferably be inserted into CAM coprocessor units 106 in parallel, according to the nature of each key. The operation would be performed, for example as described according to the algorithms below, and results would be obtained.

The results of the operation are preferably passed to a sequence merging logic 304. Sequence merging logic 304 preferably then merges these results to form a coherent set of results, for example as one or more records. This configuration is preferred, as this configuration permits division of the query and/or the data on which the query is to be performed into a plurality of portions according to a characteristic of the data, such as the key for example. Therefore, each CAM coprocessor unit 106 receives both the data and that portion of the query which are best used together to perform the operation. Sequence merging logic 304 enables the results to be transmitted back to the originating application in a manner which is most suitable for that application, without compromising on the best manner for operating CAM coprocessor unit 106.

The system according to the present invention may optionally be implemented with the main CPU addressing all of CAM coprocessor units 106 through system 300, or alternatively the main CPU may optionally address each CAM coprocessor unit 106 separately, for example through a switch (not shown).

A number of different algorithms are important for the operation of the present invention. A first such algorithm is the join algorithm. An exemplary but preferred method for performing a join operation with the device of the present invention is described with regard to FIG. 4. In SQL, a “join” is a database operation that retrieves data from more than one table. A join is characterized by multiple tables in the FROM clause, and the relationship between the tables is defined through the existence of a join condition in the WHERE clause.

There are several types of join statements in SQL (sequential query language), which are used herein as non-limiting examples of join operations: (natural) joins, anti-joins, and semi-joins. A join can be seen as the Cartesian product of 2 row sets, with the join predicate applied as a filter to the result. The join cardinality is the number of rows produced when the 2 row sets are joined together, i.e. it is the product of the cardinalities of 2 row sets, multiplied by the selectivity (the selectivity of a predicate indicates how many rows from a row set pass the predicate test—selectivity lies in a value range from 0 to 1) of the join predicate.

Star queries which join a fact table to multiple dimension tables can use bitmap indexes.

To choose an execution plan for a join statement, the query optimizer must make a number of decisions (after the initial rewrite of the original query). First, the query optimizer needs to select an access path to retrieve the data from each table in the join statement. The access path represents the number of units of work (generally the number of I/O operations) required to retrieve the data from a base table. It can be a table scan, a full index scan or a partial index scan for example.

For a join statement that joins more than 2 tables, the query optimizer chooses which pair of tables is joined first and then which table is joined to the result, and so on. The query optimizer then chooses an operation to use to perform the join operation.

In a join, one row set is called inner, and the other is called the outer row. For example, in a nested loop join, for every row in the outer row set, the inner row set is accessed to find all the matching rows to join. Therefore, in a nested loop join, the inner row set is accessed as many times as the number of rows in the outer row set.

In a sort merge join, the two row sets being joined are sorted by the join keys if they are not already in key order.

In a hash join, the inner row set is hashed into memory, and a hash table is built using the join key, which is the probe key for the join operation. Each row from the outer row set is then hashed, and the hash table is probed to join all matching rows. If the inner row set is very large, then only a portion of it is hashed into memory. This portion is called a hash partition.

Each row from the outer row set is hashed to probe matching rows in the hash partition. The next portion of the inner row set is then hashed into memory, followed by a probe from the outer row set. This process is repeated until all partitions of the inner row set are exhausted.

The present invention also encompasses a new class of join operations for use with CAM units, as described with regard to the method in FIG. 4A, which describes an exemplary equijoin operation.

As shown, in stage 1, the build table and the probe table are received. The join is to be performed according to a particular column, which is more preferably also identified to the system according to the present invention. In stage 2, records from the build table are preferably stored in the CAM unit according to the present invention. The required columns from the build table may optionally be stored in the CAM unit. Alternatively the value in the column according to which the join is to be performed and a memory pointer may optionally be stored, in which the memory pointer points to a memory location where the record resides. The CAM unit of the present invention is preferably configured to allow associative access by the value in the column according to which the join is to be performed.

In stage 3, the CAM unit preferably checks for a match for each record from the probe table. If one or more matches exist, preferably all matches are returned in stage 4. Optionally and more preferably, each match generates one output record.

The CAM join method of the present invention is applicable when the smaller table has fewer rows than the capacity of the CAM unit.

Variations on the basic join method according to the present invention may optionally and preferably be implemented, for additional join-like operations. In the following, A is assumed to be the probe table, B is assumed to be the build table, and the join is performed with regard to the values of column K (in which each table has such a column).

The first such examples are for different types of outerjoin operations. For example, for A left outerjoin B, any A records which do not have any matches are output as (K value, A columns, NULL). This avoids the situation in which non-matching records are not reported as such. Similarly, A right outerjoin B is for the situation in which one or more B records have no matches but are still to be output. Preferably, a bit is retained in the CAM unit to identify if a slot (record) matched a probe. At the end of the regular join, one or more (K value, NULL, B columns) triples is output based on those slots with a zero bit. These left and right outerjoin methods may also optionally be combined in a full outerjoin algorithm.

A semijoin operation (A semijoin B) may also optionally and preferably be performed, with similar results as to an equijoin operation (as described with regard to FIG. 4A), but no B columns are output. In the opposite operation, B semijoin A, no A columns are output. This operation results in a sequence of key lookups into table B.

Modified semijoin operations are also possible. For example, a unique semijoin operation results in output being generated at most one time for each record in a particular table. For example, A unique semijoin B, results in output being generated at most once for each record in table A.

The operation for B unique semijoin A, on the other hand, is preferably performed by processing the complete A table, but only outputting (K value, B columns) pairs with a 1 bit set, indicating a matching probe.

An antisemijoin operation results in output only if there is no match. For example, A antisemijoin B is similar to (A-B); an output is only made if there is no matching B record.

The operation for B antisemijoin A is similar to (B-A), and functions as though the B unique semijoin A operation is being performed, but pairs being output with a 0 bit set.

It should be noted that the set-oriented operations “intersection” and “difference” can optionally be implemented using semijoins and antisemijoins respectively.

Another example of a join is a nested loop join, which is useful when small subsets of data are being joined, and if the join condition is an efficient manner to access the second table. It is very important to ensure that the inner table is driven from (dependent on) the outer table. If the inner table's access path is independent of the outer table, then the same rows are retrieved for every iteration of the outer loop, degrading performance considerably. In such cases, hash joins joining the two independent row sources perform better. A nested loop join may optionally and preferably be performed as follows:

1. The optimizer determines the driving table and designates it as the outer table.

2. The other table is designated as the inner table.

3. For every row in the outer table, the database accesses all the rows in the inner table.

The outer loop is performed once for every row in outer table and the inner loop is preformed once for every row in the inner table.

Nested loop outer joins are used when an outer join is used between two tables. The outer join returns the outer table rows, even when there are no corresponding rows in the inner table. In a nested loop outer join, the order of tables is determined by the join condition. The outer table (with rows that are being preserved) is used to drive to the inner table.

Hash joins are used for joining large data sets. The optimizer uses the smaller of two tables or data sources to build a hash table on the join key in memory. It then scans the larger table, probing the hash table to find the joined rows. This method is preferred when the smaller table fits in available memory. However, if the hash table grows too big to fit into the memory, then the optimizer can break it up into different partitions, writing to temporary segments on a disk or other storage medium.

Hash outer joins are used for outer joins where the optimizer decides that the amount of data is large enough to warrant a hash join, or it is unable to drive from the outer table to the inner table. The outer table (with preserved rows) is used to build the hash table, and the inner table is used to probe the hash table.

Sort merge joins can be used to join rows from two independent sources. Sort merge joins are useful when the join condition between two tables is an inequality condition (but not a nonequality) like <, <=, >, or >=. In a merge join, there is no concept of a driving table. This type of join operation may optionally be performed as follows:

1. Sort join operation: Both inputs are sorted on the join key.

2. Merge join operation: The sorted lists are merged together.

If the input is already sorted by the join column, then a sort join operation is not performed for that row source.

Sort merge outer joins are used when an outer join cannot drive from the outer table to the inner table.

A Cartesian join is used when one or more of the tables do not have any join conditions to any other tables in the statement. The optimizer joins every row from one data source with every row from the other data source, creating the Cartesian product of the two sets.

A full outer join acts like a combination of the left and right outer joins. In addition to the inner join, rows from both tables that have not been returned in the result of the inner join are preserved and extended with nulls. In other words, full outer joins let you join tables together, yet still show rows that do not have corresponding rows in the joined tables.

An antijoin returns rows from the left side of the predicate for which there are no corresponding rows on the right side of the predicate. That is, it returns rows that fail to match (NOT IN) the subquery on the right side.

Generally, the optimizer will use a nested loops algorithm for NOT IN subqueries.

A semijoin returns rows that match an EXISTS subquery without duplicating rows from the left side of the predicate when multiple rows on the right side satisfy the criteria of the subquery.

An index join is a hash join of several indexes that together contain all the table columns that are referenced in the query. If an index join is used, then no table access is needed, because all the relevant column values can be retrieved from the indexes. An index join cannot be used to eliminate a sort operation.

A bitmap join uses a bitmap for key values and a mapping function that converts each bit position to a row identifier. Bitmaps can efficiently merge indexes that correspond to several conditions in a WHERE clause, using Boolean operations to resolve AND and OR conditions.

Some data warehouses are designed around a star schema, which includes a large fact table and several small dimension (lookup) tables. The fact table stores primary information. Each dimension table stores information about an attribute in the fact table.

A star query is a join between a fact table and a number of lookup tables. Each lookup table is joined by its primary keys to the corresponding foreign keys of the fact table, but the lookup tables are not joined to each other. A typical fact table contains keys and measures.

A star join uses a join of foreign keys in a fact table to the corresponding primary keys in dimension tables. The fact table normally has a concatenated index on the foreign key columns to facilitate this type of join, or it has a separate bitmap index on each foreign key column.

FIG. 4B(1) and FIG. 4B(2) both show exemplary flowcharts of another method according to the present invention, for aggregation algorithms. A typical relational aggregate operation is applied to a single table, which may optionally be the intermediate result obtained from a subquery. Aggregate functions are specified on columns of the source table.

For the first method, as shown in FIG. 4B(1), in stage 1, the table is grouped according to the grouping columns. In stage 2, each unique combination of values from the grouping columns has its own subtotal computed.

Alternatively, as shown in FIG. 4B(2), the current running totals are stored in a hash table, in which the grouping columns are used as a composite key. The hash table is initially empty in stage 1. As each record is processed in stage 2, the hash table is interrogated to see if the particular combination of grouping column values has been seen before. If not, then in stage 3, a new entry is made in the hash table, initialized with subtotals based on the record. If the combination does exist, then the aggregated attributes for that record are accumulated together with the current subtotal for that group, in stage 4. Stages 2-4 may optionally be repeated for each record. This type of method is operative for aggregate functions that are associative and commutative, such as sum, count, minimum and maximum. Aggregates such as average values can be derived using sum and count.

As for joins, if there are likely to be too many groups to efficiently store in a hash table, the data may optionally first be partitioned according to the grouping attributes. Each partition may then be processed separately.

FIG. 4C shows an exemplary method according to the present invention for duplicate elimination. This operation receives an arbitrary table (potentially with duplicates) as input, but outputs only one copy of each row. This operation is very similar to aggregation as defined above, with the simplification that all columns are treated together as the grouping-columns, and no subtotals are computed. Duplicate elimination can optionally be performed by using the same algorithms as aggregation.

For the aggregate operation, the running totals are preferably stored in the CAM unit. The key field is the combination of all grouping columns, and the running subtotals are stored in the associated SRAM. As shown in stage 1 of FIG. 4C, each new record is received. In stage 2, the CAM unit determines whether a new group is required or if the record may be inserted into an existing group. In stage 3, either a new row is inserted in the CAM unit, corresponding to a new group, or alternatively the record is accumulated into an existing subtotal for a group. This method is hereinafter termed “CAM aggregation”. A similar method (without computing subtotals) may optionally be applied for the duplicate elimination operation, and is hereinafter termed “CAM duplicate elimination”.

The CAM-based operations of the present invention are expected to have a number of performance advantages over conventional database techniques. For example, a CAM join does roughly the same overall work (measured in terms of comparisons) as a nested loop join. However, the CAM unit enables the detection of all matches in the build table for a record in the probe table within a small constant number of machine cycles. As a result, the CAM join may take substantially less time. Nested loops algorithms must check each potential match one by one, with the required time proportional to the product of the sizes of the inputs. By contrast, a CAM join checks matches in parallel, taking time proportional to the sum of the input sizes and the output size.

The CAM join algorithm according to the present invention overcomes a number of a number of performance hazards that would be encountered by a database system employing a hash join. For example, a hash function must satisfy two conflicting goals. It should be inexpensive to compute, since the hash function is called often. But it must also do a good job of distributing the data uniformly across the hash table address range. Different data types and data distributions might require different hash functions, depending on how the system is implemented. Hash function computation is not typically the bottleneck for hash table performance in currently available computers. In addition to executing the hash function, an additional explicit key comparison is required for every record that mapped to the given hash address. This overhead can be significant, particularly in the presence of duplicate keys in the build table (see below). These different overheads are not present during the operation of the CAM join algorithm according to the present invention.

Another such hazard for the use of the hash table is the requirement for memory capacity. A well-configured hash table is usually somewhat (say 20%) bigger than the data it is required to store. The extra space is needed in order to reduce the number of collisions in the hash table. Further, the key itself must be stored so that a hash match can be checked to see whether or not it is an exact match. Thus, the size of the table can be significantly more than would be required in a CAM-based solution. For performance reasons, hash tables should not be any larger than one or two megabytes, comparable to a CAM-based solution on modern hardware. If the hash table were to be larger, thrashing would be expected, causing a very large RAM latency on each operation. Thus, the data must be partitioned so that partitions are much smaller than main memory.

Another hazard of the hash operation as known in the art is memory contention, which occurs when many operations are performed concurrently in a CPU, each of which uses some amount of cache memory, thereby severely reducing the amount available to the hash operation. A CAM-based solution allows for the application to explicitly manage the CAM resource to avoid contention.

Another hazard for a hash based method is the presence of duplicates, since multiple records with the same key always hash to the same location. As a result, a small number of entries may have large overflow lists, with much of the rest of the table underutilized. Further, a hash collision in this context is much more detrimental to performance, because many duplicate non-matches will need to be scanned.

A CAM-based solution does not need to suffer from this problem if the underlying hardware has efficient ways to iterate through multiple matches for a lookup.

Also, unlike hash based algorithms, a CAM-based solution always has a predictable and understandable performance measure. The available capacity of the CAM must be larger than the number of rows in the build input, which is typically known in advance.

Furthermore, a conventional hash table can perform a single operation (insertion or probe) at a time. In contrast, a group of CAM units operating in parallel can effectively increase the number of operations that can be executed concurrently. Furthermore, each CAM unit is optimized so that it can operate in a pipelined fashion. Thus, unlike for conventional hash tables, a single CAM unit may have several operations active at the same time, at different stages of execution.

The present invention has a wide variety of applications for data storage, and is particularly advantageous for high demand and/or high throughput applications. Examples of such high volume applications (for reading, searching and/or writing data) include but are not limited to, telemetry, seismic processing, satellite imagery, robotic exploration, credit card validation, and any other high demand applications.

The CAM unit according to the present invention is preferably operable with any type of data, whether structured data, such as relational database data for example, or unstructured data, such as word processing documents or text which is submitted to search engines, for example. The present invention is also useful for performing database operations with many types of databases, and not only those databases which rely upon tabular data, such as relational databases for example. Instead, the present invention is also operable with object oriented databases, XML databases, or any other type of database.

It will be appreciated that the above descriptions are intended only to serve as examples, and that many other embodiments are possible within the spirit and the scope of the present invention.

What is claimed is:

1. A system for performing at least one database operation on data, comprising:
(a) a CPU for receiving a request to perform the database operation and the data;
(b) a CAM unit for receiving said request and the data from said CPU, said CAM unit operating as a co-processor, such that said CAM unit performs the database operation on the data, and returns a result to said CPU;
wherein said CPU determines whether to transmit said request and the data to said CAM unit.

2. The system of claim 1, wherein said CAM unit comprises:
(i) a CAM memory for receiving the data;
(ii) a processor memory for storing at least one instruction; and
(iii) a data processor for executing said at least one instruction to perform the database operation on the data.

3. The system of claim 2, wherein said data processor receives an execution plan from said CPU as said request, and wherein said data processor constructs code according to said at least one instruction.

4. The system of claims 2 or 3, wherein said CAM unit further comprises an SRAM memory in association with said CAM memory, for storing the data.

5. The system of any of claims 1-4, wherein the data is in a form of a plurality of tables from a relational database.

6. The system of any of claims 1-5, wherein the data comprises probe data and build table data.

7. The system of claim 1, wherein said CAM unit comprises:
(i) a CAM memory for receiving the data;
(ii) at least one data register for storing at least a part of the data; and
(iii) a data processing logic for performing the database operation.

8. The system of claim 7, wherein said data processing logic comprises at least a join and aggregation logic.

9. The system of claims 7 or 8, wherein said at least one data register further comprises a probe data register for storing probe data and a configuration register for storing configuration data for performing the database operation.

10. The system of any of claims 7-9, wherein said CAM unit further comprises an SRAM memory in association with said CAM memory, for storing the data.

11. The system of any of claims 7-10, wherein said CAM unit further comprises a bit vector flag.

12. The system of any of claims 7-11, wherein said CAM unit further comprises a input selection logic for filtering the data before the database operation is performed.

13. The system of claim 12, wherein said at least one data register further comprises a probe data register, and wherein said input selection logic filters at least a portion of the data for being stored in said probe data register.

14. The system of claim 13, wherein said at least one data register further comprises a configuration register, and wherein said input selection logic filters at least a portion of the data for being stored in said configuration register.

15. The system of any of claims 7-14, wherein said CAM unit further comprises an output selection logic for filtering at least one result from the database operation.

16. The system of any of claims 7-15, further comprising an input data interface for receiving the data and said request from said CPU, and an output data interface for transmitting at least one result of the database operation to said CPU.

17. The system of any of claims 7-16, wherein said request comprises an execution plan, and wherein said data processing logic receives said execution plan, said data processing logic constructing code for performing the database operation according to said execution plan from a plurality of predetermined building blocks.

18. The system of any of claims 1-17, further comprising:
(c) an external application for generating the database operation request.

19. The system of claim 18, further comprising:
(d) at least one input buffer for receiving the data and said request, wherein said at least one input buffer is configured to receive the data and said request according to a format output by said external application; and
(e) at least one output buffer, wherein said at least one output buffer is configured to transmit a result of said request according to an input format of said external application.

20. The system of any of claims 1-19, further comprising a plurality of CAM units for being operated in parallel, such that the data is partitioned between said CAM units according to a partitioning function.

21. The system of any of claims 1-19, further comprising a switch and a plurality of CAM units for being addressed by said CPU through said switch.

22. The system of claim 21, wherein each CAM unit is separately addressable by said CPU.

23. A method for performing at least one database operation on data from a query, comprising:
providing a CAM (content addressable memory) unit for operating as a co-processor;
storing the data in said CAM unit;
converting the query into at least one instruction to be executed by said CAM unit; and
executing said at least one instruction to obtain at least one result of the database operation.

24. The method of claim 23, wherein the database operation comprises at least one of a plurality of join, aggregation or duplicate elimination operations that are performed in parallel.

25. The method of claims 23 or 24, wherein said storing the data in said CAM unit further comprises:
receiving a plurality of input records; and
performing at least one selection operation on said input records.

26. The method of any of claims 23-25, further comprising:
performing at least one selection operation on said output result.

27. The method of 23-26, further comprising:
performing at least one database operation on a row with NULL values, according to the standard of SQL communication.

28. A device for performing at least one database operation on data from a query as a co-processor, the device comprising:
(a) a CAM memory for storing the data;
(b) a memory for storing a plurality of instructions for interacting with the data; and
(c) a CPU for executing said plurality of instructions.
